(19) United States
(12) Patent Application Publication
(10) Pub. No.: US 2026/0027941 A1
(43) Pub. Date: Jan. 29, 2026

(54) CONTROLLING VEHICLE BATTERY BASED ON OPEN CIRCUIT VOLTAGE

(71) Applicant: FORD GLOBAL TECHNOLOGIES, LLC, Dearborn, MI (US)

(72) Inventors: Gabrielle VUYLSTEKE, Ferndale, MI (US); Yonghua LI, Ann Arbor, MI (US); Donnell Matthew WASHINGTON, Northville, MI (US)

(21) Appl. No.: 18/780,715

(22) Filed: Jul. 23, 2024

(51) Int. Cl. B60L 58/12

(52) U.S. Cl. CPC B60L 58/12; B60L 2240/547

(57) ABSTRACT

Voltage data about a traction battery is written to memory for a predefined period of time responsive to opening of contactors electrically connected between the traction battery and an electric machine. Processing of the voltage data begins prior to an end of the predefined period of time to generate an open circuit voltage for the traction battery. The traction battery is charged or discharged according to power limits that are based on the open circuit voltage.

### TECHNICAL FIELD

The present disclosure generally relates to controlling a battery for an electrified vehicle. More specifically, the present disclosure relates to a system and method for controlling the battery based on an open circuit voltage (OCV).

### BACKGROUND

An electrified vehicle (EV) relies on one or more traction batteries for providing power to electric machines to propel the EV. One or more operational characteristics of the battery pack, such as power limits and state of charge (SOC), may be estimated to control the charge and discharge operation of the traction batteries.

### SUMMARY

A vehicle includes a traction battery, an electric machine, and one or more controllers that, responsive to disconnection of the traction battery and electric machine, acquire voltage data about the traction battery for a predefined period of time such that the voltage data is written to memory for the predefined period of time but not immediately after the predefined period of time, and before expiration of the predefined period of time, initiate processing of the voltage data such that utilization of a processor performing the processing increases before the predefined period of time ends.

A power system for a vehicle includes one or more controllers that, while the vehicle is parked and in a key-off mode, write voltage data associated with a battery of the vehicle to memory for a predefined period of time, and initiate processing of the voltage data prior to an end of the predefined period of time such that the processing ends after the predefined period of time and utilization of a processor performing the processing increases before the predefined period of time ends and decreases after the predefined period of time ends.

A method for a vehicle includes opening contactors electrically connected between a traction battery and an electric machine, writing voltage data about the traction battery to memory for a predefined period of time responsive to the opening, initiating processing of the voltage data prior to an end of the predefined period of time to generate an open circuit voltage for the traction battery, and charging or discharging the traction battery according to power limits that are based on the open circuit voltage.

### BRIEF DESCRIPTION OF THE DRAWINGS

FIG. 1 illustrates an example block topology of an electrified vehicle illustrating drivetrain and energy storage components of one embodiment of the present disclosure.

FIG. 2 illustrates a flow diagram of an open circuit voltage estimation process of one embodiment of the present disclosure.

FIG. 3 illustrates a flow diagram of an open circuit voltage estimation process of another embodiment of the present disclosure.

FIG. 4 illustrates a flow diagram of a process for calculating candidate β of one embodiment of the present disclosure.

### DETAILED DESCRIPTION

Embodiments are described herein. It is to be understood, however, that the disclosed embodiments are merely examples and other embodiments may take various and alternative forms. The figures are not necessarily to scale. Some features could be exaggerated or minimized to show details of particular components. Therefore, specific structural and functional details disclosed herein are not to be interpreted as limiting, but merely as a representative basis for teaching one skilled in the art.

Various features illustrated and described with reference to any one of the figures may be combined with features illustrated in one or more other figures to produce embodiments that are not explicitly illustrated or described. The combinations of features illustrated provide representative embodiments for typical applications. Various combinations and modifications of the features consistent with the teachings of this disclosure, however, could be desired for particular applications or implementations.

The present disclosure, among other things, proposes a system and method for controlling a traction battery of an EV based on an open circuit voltage.

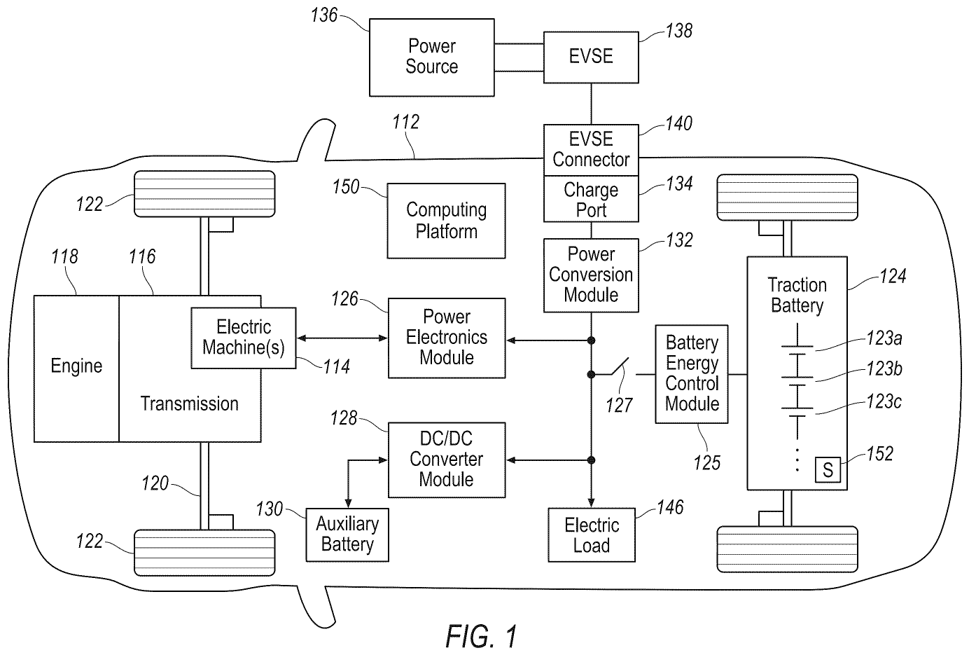

FIG. 1 illustrates a plug-in hybrid-electric vehicle (PHEV). A plug-in hybrid-electric vehicle 112 may include one or more electric machines (electric motors) 114 mechanically coupled to a hybrid transmission 116. The electric machines 114 may be capable of operating as a motor or a generator. In addition, the hybrid transmission 116 is mechanically coupled to an engine 118. The hybrid transmission 116 is also mechanically coupled to a drive shaft 120 that is mechanically coupled to the wheels 122. The electric machines 114 may provide propulsion and slowing capability when the engine 118 is turned on or off. The electric machines 114 may also function as generators and may provide fuel economy benefits by recovering energy that would be lost as heat in the friction braking system. The electric machines 114 may also reduce vehicle emissions by allowing the engine 118 to operate at more efficient speeds and allowing the hybrid-electric vehicle 112 to be operated in electric mode with the engine 118 off under certain conditions.

A traction battery or battery pack 124 stores energy that may be used by the electric machines 114. A vehicle battery pack 124 may include a plurality of battery cells 123 connected in series and/or in parallel to provide a high voltage DC output. In one example, the battery cells 123 may be permanently fixed to a housing of the traction battery 124 and not removable. In an alternative example, the battery cells 123 may be individually removable to allow the user to replace one or more cells. It is noted that the term battery cell is used as a general term in the present disclosure and may refer to a single battery cell, an array of battery cells connected in series or the like.

The traction battery 124 may be electrically coupled to one or more battery energy control modules (BECM) 125. The BECM 125 may be provided with one or more processors, memory, and software applications configured to monitor and control various operations of the traction battery 124. The traction battery 124 may be further electrically coupled to one or more power electronics modules 126. The power electronics module 126 may also be referred to as a power inverter. One or more contactors 127 may isolate the traction battery 124 and the BECM 125 from other components when opened and couple the traction battery 124 and the BECM 125 to other components when closed. The contactors 127 may be operated by the BECM 125 for instance. The power electronics module 126 may also be electrically coupled to the electric machines 114 and provide the ability to bi-directionally transfer energy between the traction battery 124 and the electric machines 114. For example, a traction battery 124 may provide a DC voltage while the electric machines 114 may operate using a three-phase AC current. The power electronics module 126 may convert the DC voltage to a three-phase AC current for use by the electric machines 114. In a regenerative mode, the power electronics module 126 may convert the three-phase AC current from the electric machines 114 acting as generators to the DC voltage compatible with the traction battery 124. The description herein is equally applicable to a pure electric vehicle. For a pure electric vehicle, the hybrid transmission 116 may be a gear box connected to the electric machine 114 and the engine 118 may not be present.

In addition to providing energy for propulsion, the traction battery 124 may provide energy for other vehicle electrical systems. A vehicle may include a DC/DC converter module 128 that converts the high voltage DC output of the traction battery 124 to a low voltage DC supply that is compatible with other low-voltage vehicle loads. An output of the DC/DC converter module 128 may be electrically coupled to an auxiliary battery 130 (e.g., 12V battery).

The vehicle 112 may be a battery electric vehicle (BEV) or a plug-in hybrid electric vehicle (PHEV) in which the traction battery 124 may be recharged by an external power source 136. The external power source 136 may be a connection to an electrical outlet. The external power source 136 may be an electrical power distribution network or grid as provided by an electric utility company. The external power source 136 may be electrically coupled to electric vehicle supply equipment (EVSE) 138. The EVSE 138 may provide circuitry and controls to manage the transfer of energy between the power source 136 and the vehicle 112. The external power source 136 may provide DC or AC electric power to the EVSE 138. The EVSE 138 may have a charge connector 140 for plugging into a charge port 134 of the vehicle 112. The charge port 134 may be any type of port configured to transfer power from the EVSE 138 to the vehicle 112. The charge port 134 may be electrically coupled to a charger or on-board power conversion module 132. The power conversion module 132 may condition the power supplied from the EVSE 138 to provide the proper voltage and current levels to the traction battery 124. The power conversion module 132 may interface with the EVSE 138 to coordinate the delivery of power to the vehicle 112. The EVSE connector 140 may have pins that mate with corresponding recesses of the charge port 134. Alternatively, various components described as being electrically coupled may transfer power using a wireless inductive coupling.

One or more electrical loads 146 may be coupled to the high-voltage bus. The electrical loads 146 may have an associated controller that operates and controls the electrical loads 146 when appropriate. Examples of electrical loads 146 may be a heating module, an air-conditioning module, or the like.

The various components discussed may have one or more associated controllers to control and monitor the operation of the components. The controllers may communicate via a serial bus (e.g., Controller Area Network (CAN)) or via discrete conductors. A system controller 150 may be present to coordinate the operation of the various components. It is noted that the system controller 150 is used as a general term and may include one or more controller devices configured to perform various operations in the present disclosure. For instance, the system controller 150 may be programmed to enable a powertrain control function to operate the powertrain of the vehicle 112. The system controller 150 may be further programmed to enable a telecommunication function with various entities (e.g., a server) via a wireless network (e.g., a cellular network).

The traction battery 124 may be further provided with one or more sensors 152 configured to measure one or more characteristics of the battery cells including, but not limited to, electric current, voltage, temperature or the like. The BECM 125 may be configured to communicate with the sensors 152 to receive and process the data measurements.

In general, to manage the traction battery 124 of the vehicle 112, the vehicle system needs to know a state of charge (SOC) of the battery pack to estimate the power capability/power limit of the battery pack. For most battery chemistries, the SOC is estimated based on an open circuit voltage (OCV) of the battery pack, which is the voltage of the battery pack at rest. In a non-limiting example, for hybrid electric vehicles (HEV), with the sizes of the battery cells typically being about five (5) ampere-hours, the OCV may stabilize within 30 minutes, but may take longer at colder temperatures. Specifically, stabilization is when the active material equally distributes (through diffusion) across the thickness of an electrode, and the time it takes to reach stabilization may be referred to as equilibrium time for the battery cell. Battery charge and discharge reactions occur at the electrode surface. As battery cells get bigger (e.g., increase in size), the electrodes tend to get thicker and thus, the equilibrium time may increase. In some cases, it may take a few hours for the OCV to stabilize.

In various situations, it may be difficult for the vehicle 112 to rest (i.e., no charging or discharging) for such long equilibrium times. For example, in one situation, the vehicle 112 may only stop for a brief period (e.g., less than 1 hour) before being restarted. In another example, the vehicle 112 may stop at a charging station for a fast charge for a few minutes.

Furthermore, the number of battery cells employed in the traction battery may also influence the detection of the OCV, which may be measured for each battery cell. Specifically, some traction batteries may include about 100 cells in series, and with the EV moving towards higher electric power systems (e.g., 800V to 1200V), the number of battery cells may double or even triple, thereby increasing computational requirements of the vehicle system.

The present disclosure proposes a vehicle system configured to operate the charge and discharge of the traction battery 124 based on an estimated OCV of one or more battery cells 123. More specifically, the BECM 125 may estimate the OCV using voltage measurements, a temperature measurement, and a decay parameter that is a function of the voltages since a last deactivation of the traction battery 124 and detected using a selected relaxation time and an iterative estimation of a sub-parameter of the decay parameter.

Additionally, the BECM 125 may perform the OCV estimation before all data are collected. In contrast to a conventional approach in which the OCV estimation only starts after all data is collected, the present disclosure proposes a system and method that performs the OCV estimation in parallel with the data collection. In other words, the BECM 125 may start the OCV estimation once some data have been collected and perform the OCV estimation in parallel with the process while the rest of the battery data are being collected. In this way, the general processing task of the OCV estimation may be more evenly distributed across a longer period of time, reducing the peak burden of the BECM 125. Utilization of the processor may thus increase before the predefined period during which data are being collected ends and decrease after the predefined period ends. In a non-limiting example, the OCV may be estimated for each battery cell 123, and then aggregated to determine the OCV for the traction battery 124. With the estimated OCV, the vehicle system (e.g., the BECM 125, and/or the system controller 150) may estimate a SOC, provide an available energy at the beginning of a drive cycle which is used to predict a vehicle drive range, and/or provide a power limit estimation, among other actions (e.g., output a SOH).

In one example, the BECM 125 may be configured to estimate the OCV based on voltages measured by the sensors 152 after a last deactivation of the vehicle 112 and a decay parameter that is a function of the voltages and a duration since the last deactivation. More specifically, the BECM 125 may estimate the OCV for a battery cell 123 using the following equation:

$$V = {V}_{OCV} + β {e}^{- \sqrt{kt}} \qquad ( 1 )$$

wherein V denotes the voltage of the battery cell 123 measured by the sensors 152, and βe^{-\sqrt{kt}} represents a decay parameter associated with the battery cell 123.

The decay parameter may be associated with a non-linear correlation with voltage in that, after deactivation of the vehicle 112, the rate of change of voltage with time is not constant. As reflected in equation (1), the decay parameter may characterize the decaying voltage using an exponential parameter involving a square root of the duration, and further include a coefficient and a constant that are a function of the voltages and battery temperature. In the example presented in equation (1), the decay parameter includes sub-parameters such as β, k, and t. β denotes a coefficient related to SOC, temperature, and the magnitude of the current before contactors open; k denotes a time constant that is related to a diffusion coefficient in the electrodes, and may follow an Arrhenius relationship (i.e., k=Ae^{-E}^{_{π}}^{/RT}); and t denotes time.

More specifically, β can be calculated using voltages at time t and with reference to time=0 (i.e., βt) may be defined as equation (2) below:

$${β}_{t} = \frac{V ( t ) - V ( 0 )}{{e}^{- \sqrt{k * t}} - 1} \qquad ( 2 )$$

wherein V(t) is a voltage measurement at time t and V(0) is voltage measured at time t=0 seconds. Specifically, when t=0, equation (1) turns to V(0)=V_{OCV}+β, and therefore V_{OCV}=V(0)−β. Substituting V_{OCV} in equation (1) with “V(0)−β,” β is then represented by equation (2).

In a non-limiting example, equation (3) provides β_{60sec} below:

$${β}_{60 sec} = \frac{V ( t = 60 ) - V ( 0 )}{{e}^{- \sqrt{k * 60}} - 1} \qquad ( 3 )$$

The sign of β is dependent on the direction of the current just before the traction battery 124 is disconnected from the vehicle 112 via the main contactor 127. That is, if the traction battery 124 was being (predominately) discharged just before deactivation, the sign of β is negative indicating the voltage will be lower than the OCV. If the traction battery 124 was being (predominately) charged, the sign of β is positive indicating the voltage will be higher than the OCV.

In some examples, the decay parameter, and specifically β and k, may be estimated using complex regression models using voltage measurements taken for a selected duration, such as one minute (i.e., 60 seconds). However, such estimation operations may require a lot of processing power from the BECM 125.

As detailed herein, k may be defined in terms of β. β, in turn, may be estimated using a selected relaxation time (t_{RELAX}) from among a plurality of calibrated relaxation times, and by comparing predicted β (i.e., β_{PRED}) across a range of candidate β (β_{CAND}). For instance, at a relaxation time T_{RELAX} which is some time after the deactivation of the vehicle, and voltage measurement becomes relatively accurate and is less than or equal to a voltage sensor error (V_{SE}) (error band) (e.g., t=t_{RELAX}), |V(t_{RELAX})−OCV|≤V_{SE}. In one embodiment, the relaxation time may be a predetermined fixed period of time. Additionally or alternatively, the relaxation time may be estimated based on a temperature of the battery pack 106, an absolute delta voltage (i.e., absolute change in voltage) estimated using at least a portion of the voltages measured, and relaxation time correlation data that associates selected inputs (e.g., the temperature and the absolute delta voltage) to associated relaxation times. In a non-limiting example, the relaxation correlation data is provided as one or more look-up tables.

By setting time as the relaxation time in equation (2), k may be expressed as a function of β_{CAND}, V_{SE}, and the relaxation time (t_{RELAX}), as provided in equation (4).

$$k = \frac{{ln [ \frac{{V}_{SE}}{{β}_{cand}} ]}^{2}}{{t}_{RELAX}} \qquad ( 4 )$$

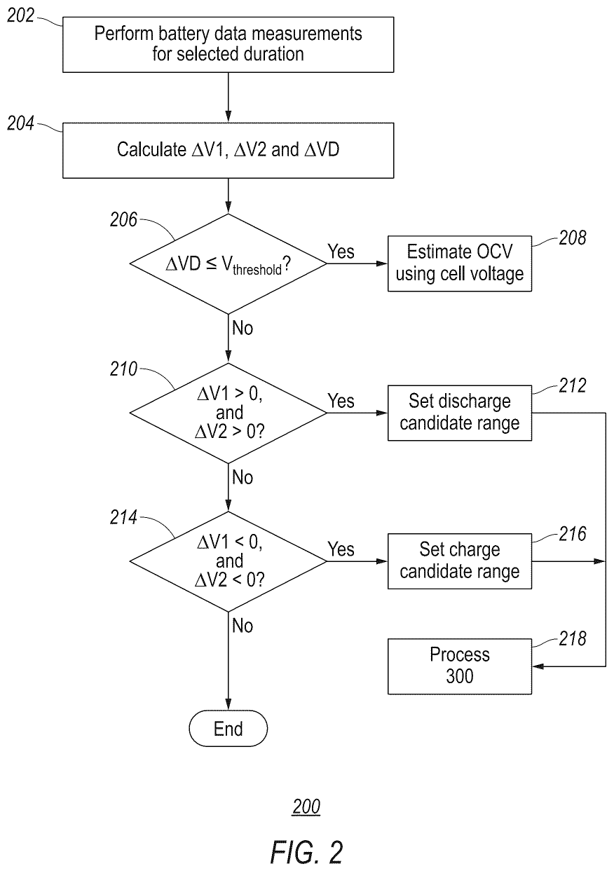

Referring to FIG. 2, an example OCV estimation process 200 of one embodiment of the present disclosure is illustrated. With continuing reference to FIG. 1, the process 200 may be implemented via one or more components of the vehicle 112. For instance, the process 200 may be individually implemented via the BECM 125. Alternatively, the process 200 may be collectively implemented via the BECM 125 in combination with other components (e.g., the system controller 150) of the vehicle 112. For simplicity, the following description will be made with reference to the BECM 125 although the present disclosure is not limited thereto. As detailed herein, the BECM 125 estimates the OCV of the battery cells 123 by summing voltages measured for a predefined duration after a last deactivation of the vehicle 112 and a decay parameter. As discussed above the decay parameter considers a plurality of sub-components that are obtainable using the above equations. The BECM 125 (and/or the system controller 150) may be configured to charge and discharge the traction battery using power limits defined at activation of the vehicle 112 by the estimated OCV.

At operation 202, the BECM 125 performs data measurements and writes the same to memory for a set predefined duration after deactivation to collect battery data indicative of conditions of one or more battery cells. The battery data may include various entries. For instance, the battery data may include a plurality of voltages and a plurality of temperatures (T) of one or more battery cells 123 at various times during the duration.

More particularly, when the BECM 125 receives a deactivation request from the system controller 150 to electrically disconnect the traction battery 124 from the electric machine 114, the contactor 127 is opened, and the sensors 152 measure the voltage for the battery cells 123 for a selected duration (e.g., 60 seconds), and then discontinue the measuring. In one example, the duration is less than a stabilization time for active material of each of the battery cells 123 to equally distribute across an electrode of the battery cell 123. The cell temperature may be measured at the same time as the voltage is measured. Alternatively, the temperature may be measured only occasionally at the beginning and/or end of the selected duration after the contactor 210 is opened as continuous temperature data measurements may not be required to perform the OCV estimation.

At operation 204, the BECM 125 determines if the traction battery 124 was significantly charging or discharging prior to deactivation. More specifically, the BECM 125 calculates a plurality of delta voltages ΔV to assess if the voltage is substantially decreasing or increasing since the deactivation of the vehicle 112. In the present non-limiting example, the BECM 125 calculates three delta voltage values ΔV1, ΔV2, and ΔVD using ΔV1=V(t₁)−V(0), ΔV2=V(t₂)−V(0), and ΔVD=|V(t_{D})−V(0)| where: V(t_{D}) is voltage measured at the end of the duration; V(t₁) is voltage measured at time=t₁, where t₁ is a time between to and the duration (e.g., if the duration is 60 seconds, t₁ may be 20 seconds); where t₂ is a time between t₁ and the duration (e.g., if the duration is 60 seconds and t₁ is 20 seconds, t₂ may be 40 seconds); and V(0) is voltage measured at to when the EV 100 is deactivated.

At operation 206, the BECM 125 determines if the voltage is at relaxation, or stated differently, if the voltage measured is the OCV. More specifically, at operation 206, the BECM 125 determines if the ΔVD is less than or equal to a voltage delta threshold (V_{threshold}) (i.e., |V(t_{D})−V(0)|≤V_{threshold}). If so, the BECM 125 estimates the OCV by, for example, averaging the voltage measured at t₁ for the battery cells 123. This may occur in various scenarios, such as, but not limited to, the vehicle 112 has been turned off for a long time (e.g., a couple of hours) and the battery cells have been fully rested, then the vehicle 112 being turned on for a few minutes, and then being turned off without significant charge or discharge. In such cases, the short activation of the vehicle 112 may be insignificant in affecting the OCV of the battery cells 123 and the voltage measured may be indicative of OCV. The voltage delta threshold may be selected to detect a significant voltage rise or fall using the voltage measured for the duration. In a non-limiting example, the voltage delta threshold may be provided as 4*V_{SE}.

If the answer for operation 206 is yes, i.e., the ΔVD≤V_{threshold} indicative of the voltage is at relaxation, the process 200 proceeds to operation 208 and the BECM estimates the OCV using the measured cell voltage. Otherwise, if the voltage is not at relaxation (i.e., ΔVD>V_{threshold}), the BECM 125 needs to determine if the EV 100 was charging or discharging prior to deactivation to determine the sign of the decay parameter.

At operation 210, the BECM 125 determines if the delta voltage values are greater than zero (i.e., ΔV1>0 and ΔV2>0). If the delta voltage values are both greater than zero, the BECM 125 determines the vehicle 112 was discharging prior to deactivation. Therefore, at operation 212, the BECM 125 sets a discharge candidate range at a defined iteration step size for β. More specifically, for the iterative estimation, the BECM 125 may employ a sub-parameter candidate range of values for β in response to detecting that the battery pack 106 was discharging prior to the last deactivation. As described above, β is a negative value when the vehicle 112 was discharging. The BECM sets the β-candidate range to a discharging range where the β candidate range is provided as V(0)−OCV(Full_SOC)≤β_{CAND}≤0 in which OCV(Full_SOC) is the OCV when the SOC is at 100%, which may be defined and stored by the BECM 125, and V(0) is the voltage measured at time zero to.

If the answer for operation 210 is no, indicative of the traction battery 124 not discharging prior to deactivation, the process 200 proceeds to operation 214 to determine if both of the delta voltage values are less than zero (i.e., ΔV1<0 and ΔV2<0). If the delta voltage values are both less than zero, the BECM 125 determines the vehicle 112 was charging prior to deactivation. Therefore, at operation 216, the BECM 125 sets a charge candidate range at a defined iteration step size for β. More specifically, for the iterative estimation, the BECM 125 may employ a sub-parameter candidate range of values for β in response to detecting that the battery pack 106 was charging prior to the last deactivation. As described above, β is a positive value when the vehicle 112 was charging. The BECM sets the B-candidate range to a charging range where the β candidate range is provided as 0≤β_{CAND}≤V(0)−OCV(Empty_SOC) in which OCV(Empty_SOC) is the OCV when the SOC is at 0%, which may be defined and stored by the BECM 125, and V(0) is the voltage measured at time zero to.

Otherwise, if the BECM 125 is unable to determine either charging or discharging, the process 200 ends at operation 220 without determining OCV.

If, however, the process 200 arrives at either operation 212 or 216, the process proceeds to operation 218 to perform process 300.

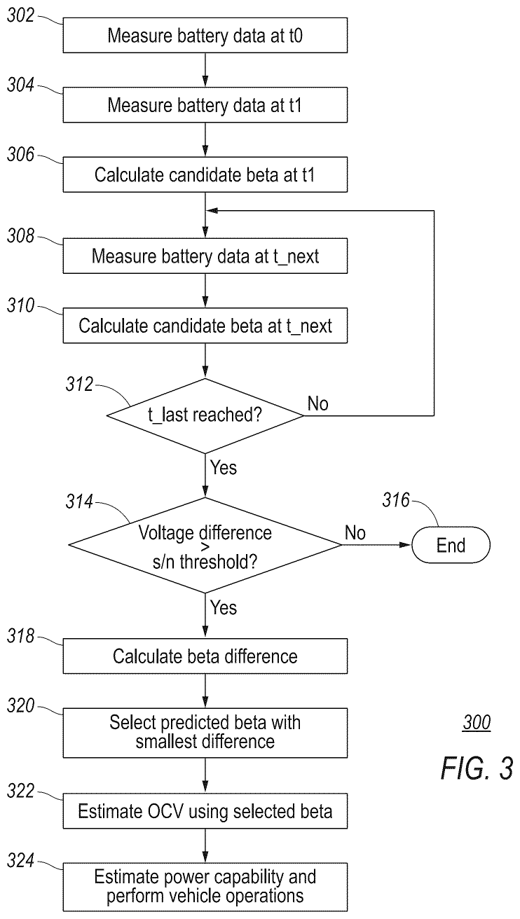

Referring to FIG. 3, an example OCV estimation process 300 of one embodiment of the present disclosure is illustrated. It is noted that, although the process 300 is described following the process 200, the present disclosure is not limited thereto and both processes 200 and 300 may independently implemented via one or more components of the vehicle system. Similarly, the following description will be made with reference to the BECM 125 for simplicity although the present disclosure is not limited thereto.

At operation 302, responsive to detecting the vehicle has been deactivated, the BECM 125 measures the battery data associated with one or more battery cells 123 at time zero to. The time zero t₀ may be defined as the time at which the main contactor 127 is open, electrically disconnecting the traction battery 124 from vehicle 112. As discussed above, the battery data may include various entries. The battery data include the voltage of the battery cell 123 at time zero V(0) via the sensor 152. V(0) may be used as a reference voltage to which one or more subsequently measured voltages are compared for calculating various parameters. Additionally, the battery data may further include a temperature of the battery cell 123 although the temperature data is not required but optional in the present example.

The BECM 125 may be configured to perform the battery data measurements at a plurality of predefined subsequent time indexes to facilitate the OCV estimation. At operation 304, responsive to detecting a first time index t₁ after time zero t₀ has been reached, the BECM 125 measures the battery data including the cell voltage V(t₁) along with other battery data entries when applicable. The time indexes may be predefined and selected based on the duration. For example, if the duration is 60 seconds, the first time index t₁ may be 20 seconds (and the second time index may be between 20 and 60 seconds).

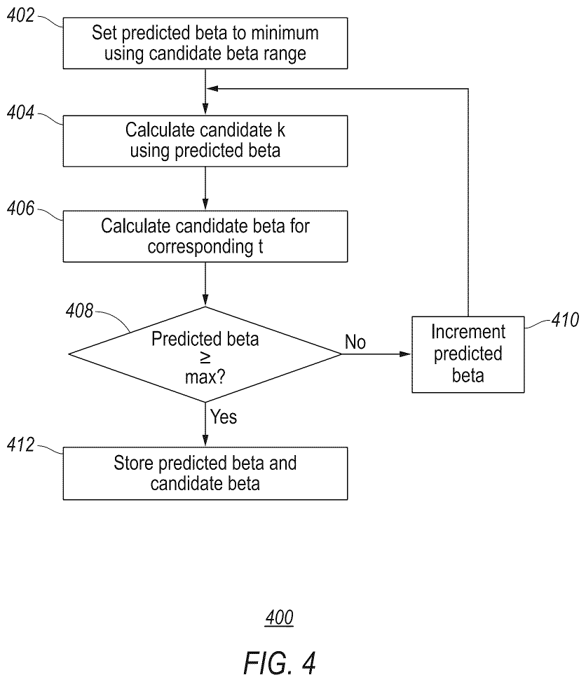

Once the voltage at the first time index V(t₁) has been obtained, at operation 306, the BECM 125 calculates the candidate β_{CAND} using V(t₁). The detailed process for calculating the candidate β_{CAND} at the first time index t₁ (as well as at all subsequent time indexes) is illustrated in FIG. 4.

Referring to FIG. 4, an example process 400 for calculating the candidate β_{CAND} at various time indexes of one embodiment of the present disclosure is illustrated. With continuing reference to FIG. 3, the following description will be made primarily with reference to operation 306 for calculating the candidate β_{CAND} at the first time index t₁ also the process 400 is also applicable to calculating the candidate β_{CAND} at other time indexes under essentially the same principle.

At operation 402, the BECM 125 sets a value for a predicted β (β_{PRED}) to the minimum possible value of β, which is defined by the β candidate range according to operations 212 or 216 described above. For example, for the discharging range, β_{PRED}=V(0)−OCV(Full_SOC), and for the charging range, β_{PRED}=0V.

At operation 404, using the β_{PRED}, the BECM 125 calculates a candidate k_{CAND}. In a non-limiting example, the candidate k_{CAND} may be calculated using equation (4). The relaxation time t_{RELAX} used in equation (4) may be detected or selected using the relaxation time correlation data with inputs including temperature and an absolute delta voltage that is estimated using at least a portion of the voltages measured (e.g., ΔVD) as discussed above. In one example, the temperature and voltage measurements used are taken at about the same time, which may be determined using a time stamp associated with the measurements.

At operation 406, the BECM 125 estimates β-candidate at a first time index (β_{CAND_t1}) using the candidate k_{CAND}, and voltage measurements associated with the first time index. In the present example, the BECM 125 estimates the candidate β_{CAND} at a first time index independently. More specifically, since the process 400 for estimating the candidate β_{CAND} for the first time index t₁ starts right after the battery data for t1 has been measured and before a subsequent time index is reached, only the battery data associated with the first time index t₁ is available for the moment being. The BECM 125 uses the following equation to determine the candidate β_{CAND} at a selected time index (e.g., β_{CAND_t1}) in which V(t) is the voltage measured at the time index and t is the time index (e.g., t₁).

$${β}_{CAND \_ t} = \frac{V ( t ) - V ( 0 )}{{e}^{- \sqrt{{k}_{CAND} * t}} - 1} \qquad ( 5 )$$

At operation 408, the BECM 125 determines if the predicted β_{PRED} is greater than or equal to a maximum possible value of β (i.e., β_{MAX}), which is defined by the β candidate range at operation 212 or 216. For example, for the discharging range, the maximum possible value of β is zero and for the charging range, the maximum possible value of β is V(0)−OCV(Empty_SOC).

If the predicted β_{PRED} is not greater than or equal to the maximum possible value of β, the process 400 proceeds to operation 410 and the BECM 125 increments β_{PRED} based on the iteration step size. That is, the BECM 125 iteratively increments the value of the predicted β based on a selected step size to estimate β-candidates at the time indexes across the β-candidate range. In a non-limiting example, the step size is set to within a range between 1 and 10 mV. A small iteration step size provides a more refined evaluation of β, but also increases the computational load compared to a larger iteration step size.

If the predicted β_{PRED} is greater than the maximum possible value of β, indicative of all possible options within the range having been processed, the process 400 proceeds to operation 412 and the BECM 125 stores the various predicted β_{PRED} and the candidate β_{CAND} in an onboard storage for future use. As discussed above, the processing for each time index t is performed individually (e.g., in parallel). Thus, when the processing for a preceding time index (e.g., t₁) completes, the process for a subsequent time index (e.g., t₂, t₃ . . . , tₙ) may not have completed (or even started) yet. In one example, the predicted β_{PRED} may not be selected until the processing for all time indexes are complete.

Returning to process 300 illustrated with reference to FIG. 3, responsive to a subsequent time index t_{NEXT} having been reached, at operation 308, the BECM 125 measures battery data at t_{NEXT}. The battery data includes the voltage measured by the sensor 152 at t_{NEXT}. Additionally, the battery data may include the cell temperature at t_{NEXT}.

At operation 310, the BECM 125 processes the battery data collected at t_{NEXT} to calculate the corresponding candidate β_{CAND} using the process 400 in essentially the same manner as discussed above with reference to operation 306. Operations 308 and 310 may be performed in parallel to operation 306. In other words, when the battery data for subsequent time index t_{NEXT} is measured and the data processing is performed, the data processing for the preceding time index may be performed in parallel or has been completed.

As discussed above, a plurality of time indexes after time zero t₀ may be used to determine the predicted β_{PRED}. At operation 312, the BECM 125 determines the last time index t_{LAST} has been reached and corresponding battery data has been measured. In one example, the last time index corresponds to the end of the predefined duration t_{D} after the deactivation of the vehicle 112. If the current time index is not the last time index, indicating more predefined time indexes are to follow, the process returns to operation 308.

Otherwise, if the last time index has been reached, and the BECM 125 is currently processing or has completed the processing for the last time index t_{LAST}, the process proceeds to operation 314. At operation 314, the BECM 125 determines if the voltage measured is the OCV similar to operation 208 discussed above. The BECM 125 determines if the ΔVD which is the difference between the beginning (e.g., to) and the end (e.g., VD) of the predefined duration is greater than a voltage delta threshold (V_{threshold}) (i.e., |V(t_{D})−V(0)|>V_{threshold}). In one example, the β processing described in process 300 is only applicable when the ΔVD is more than four times greater than the signal-to-noise ratio of the sensor accuracy (i.e., ΔVD>4*V_{SE}). In one example, if the sensor accuracy is 1.5 mV, the ΔVD will need to be more than 6 mV (i.e., 4*1.5 mV) to make the process 300 applicable.

If the above condition is not met, the process 300 ends at operation 316 and the BECM estimates the OCV using the measured cell voltage. Otherwise, the process 300 proceeds to operation 318 and the BECM 125 estimates a difference between the candidate β_{CAND-t} at various time indexes. Generally, β should be constant and thus, the smaller the difference between β_{CAND-t}, the more accurate the candidate β_{CAND} is to a true β at OCV. In a non-limiting example, the BECM 125 calculates a percent error or difference (i.e., % β_{DIFF}) using the equation below.

$$\% {β}_{DIFF} = \vert ( \frac{{β}_{CAND \_ t \_ prior} - {β}_{CAND \_ t \_ next} )}{{β}_{CAND \_ t \_ prior}} ) \vert \qquad ( 6 )$$

wherein β_{CAND_t__prior} denotes the candidate β_{CAND} at a preceding time index (e.g., t₁), and β_{CAND_t_next} denotes the candidate β_{CAND} at a subsequent time index (e.g., t₁, t₂, or t_{D}). The preceding time index t_{PRIOR} and the subsequent time index t_{NEXT} do not need to be adjacent to each other. In other words, there may be one or more time indexes located in-between the preceding time index t_{PRIOR} and the subsequent time index t_{NEXT} presented in equation (6).

At operation 320, the BECM 125 selects the value of β as the value of the candidate β_{CAND} having the smallest % β_{DIFF}. For example, the BECM 125 uses the value of the β_{CAND}-t having the lowest % β_{DIFF} as the value of β. In one example, of all β search values, there may be one value that gives the closest estimation of OCV and is between β_{CAND_tx} and β_{CAND_ty} wherein t_{X} and t_{Y} are different time indexes. Accordingly, the BECM 125 may determine the β value between β_{CAND_tx} and β_{CAND_ty} using various techniques, such as but not limited to interpolation.

At operation 322, the BECM 125 estimates the OCV using OCV=V(0)−β. With the OCV, the BMM 132 is configured to estimate an initial state of charge of the battery pack based on the estimated OCV, where the power limits are defined, in part, by the initial state of charge.

At operation 324, the BECM 125 estimates the power capability of the traction battery 124 based on the OCV and performs vehicle operations such as charging and discharging accordingly.

The algorithms, methods, or processes disclosed herein can be deliverable to or implemented by a computer, controller, or processing device, which can include any dedicated electronic control unit or programmable electronic control unit. Similarly, the algorithms, methods, or processes can be stored as data and instructions executable by a computer or controller in many forms including, but not limited to, information permanently stored on non-writable storage media such as read only memory devices and information alterably stored on writeable storage media such as compact discs, random access memory devices, or other magnetic and optical media. The algorithms, methods, or processes can also be implemented in software executable objects. Alternatively, the algorithms, methods, or processes can be embodied in whole or in part using suitable hardware components, such as application specific integrated circuits, field-programmable gate arrays, state machines, or other hardware components or devices, or a combination of firmware, hardware, and software components.

While exemplary embodiments are described above, it is not intended that these embodiments describe all possible forms encompassed by the claims. The words used in the specification are words of description rather than limitation, and it is understood that various changes may be made without departing from the spirit and scope of the disclosure. The words processor and processors may be interchanged herein, as may the words controller and controllers.

As previously described, the features of various embodiments may be combined to form further embodiments of the invention that may not be explicitly described or illustrated. While various embodiments could have been described as providing advantages or being preferred over other embodiments or prior art implementations with respect to one or more desired characteristics, those of ordinary skill in the art recognize that one or more features or characteristics may be compromised to achieve desired overall system attributes, which depend on the specific application and implementation. These attributes may include, but are not limited to strength, durability, marketability, appearance, packaging, size, serviceability, weight, manufacturability, ease of assembly, etc. As such, embodiments described as less desirable than other embodiments or prior art implementations with respect to one or more characteristics are not outside the scope of the disclosure and may be desirable for particular applications.

What is claimed is:

1. A vehicle comprising:
a traction battery;
an electric machine; and
one or more controllers programmed to, responsive to disconnection of the traction battery and electric machine, acquire voltage data about the traction battery for a predefined period of time such that the voltage data is written to memory for the predefined period of time but not immediately after the predefined period of time, and before expiration of the predefined period of time, initiate processing of the voltage data such that utilization of a processor performing the processing increases before the predefined period of time ends.

2. The vehicle of claim 1, wherein the one or more controllers are further programmed to generate an open circuit voltage associated with the traction battery as a result of the processing.

3. The vehicle of claim 2, wherein the one or more controllers are further programmed to charge or discharge the traction battery according to power limits that are based on the open circuit voltage.

4. The vehicle of claim 1 further comprising contactors, wherein opening of the contactors results in the disconnection.

5. The vehicle of claim 1, wherein the predefined period of time occurs while the vehicle is parked.

6. The vehicle of claim 5, wherein the predefined period of time occurs while the vehicle is in a key-off mode.

7. The vehicle of claim 1, wherein the processing ends after the predefined period of time ends such that the utilization decreases after the predefined period of time ends.

8. A power system for a vehicle, comprising:
one or more controllers programmed to, while the vehicle is parked and in a key-off mode, write voltage data associated with a battery of the vehicle to memory for a predefined period of time, and initiate processing of the voltage data prior to an end of the predefined period of time such that the processing ends after the predefined period of time and utilization of a processor performing the processing increases before the predefined period of time ends and decreases after the predefined period of time ends.

9. The power system of claim 8, wherein the one or more controllers are further programmed to generate an open circuit voltage associated with the battery as a result of the processing.

10. The power system of claim 9, wherein the one or more controllers are further programmed to charge and discharge the battery according to power limits that are based on the open circuit voltage.

11. The power system of claim 8, wherein the one or more controllers are further programmed to write the voltage data responsive to disconnection of the battery with an electric machine of the vehicle.

12. The power system of claim 11, wherein opening of contactors of the vehicle results in the disconnection.

13. A method for a vehicle, comprising:
opening contactors electrically connected between a traction battery and an electric machine;
writing voltage data about the traction battery to memory for a predefined period of time responsive to the opening;
initiating processing of the voltage data prior to an end of the predefined period of time to generate an open circuit voltage for the traction battery; and
charging or discharging the traction battery according to power limits that are based on the open circuit voltage.

14. The method of claim 13 further comprising completing the processing after the end of the predefined period of time.

15. The method of claim 13, wherein the opening occurs while the vehicle is parked.
